(19) United States
(12) Patent Application Publication
(10) Pub. No.: US 2025/0236185 A1
(43) Pub. Date: Jul. 24, 2025

(54) SYSTEM OF MINING EQUIPMENT DEVICES COMPRISING FUEL CELLS

(71) Applicant: EPIROC ROCK DRILLS AKTIEBOLAG, Örebro (SE)

(72) Inventor: Anders PERSSON, Hammarö (SE)

(21) Appl. No.: 18/699,524

(22) PCT Filed: Oct. 5, 2022
(86) PCT No.: PCT/SE2022/050891

§ 371 Date: Apr. 8, 2024

(30) Foreign Application Priority Data
Oct. 8, 2021 (SE) 2151239-7

(51) Int. Cl. B60L 50/75; B60L 58/12; B60L 58/16; B60L 58/18; B60L 58/40; E21B 7/02; H01M 8/04537; H01M 8/04858; H01M 10/44; H01M 10/46; H01M 10/48; H01M 16/00; H02J 7/00

(52) U.S. Cl. CPC B60L 50/75; B60L 58/12; B60L 58/16; B60L 58/18; B60L 58/40; E21B 7/025; H01M 8/04626; H01M 8/04947; H01M 10/44; H01M 10/46; H01M 10/48; H01M 16/006; H02J 7/0068; B60L 2200/40; H01M 2220/20; H01M 2250/20; H02J 7/0048; H02J 7/005

(57) ABSTRACT

A rock drilling rig including at least a primary power source, a secondary power source and one control unit, wherein the control unit is configured to control the rock drilling rig to perform work tasks according to a work cycle, both the primary and the secondary power source are configured to selectively providing operating power to the rock drilling rig, the primary power source is a fuel cell with a fuel tank, and the secondary power source is an electrical battery, and the control unit is additionally configured to control a charge of the electrical battery with power from the primary power source, simultaneously as supplying operating power to the rock drilling rig.

### TECHNICAL FIELD

The present disclosure relates generally to mining equipment devices and especially to rock drilling rigs comprising a primary power source and a secondary power source. The present disclosure further relates to a system of mining equipment comprising at least a rock drilling rig comprising a primary power source and a secondary power source. Furthermore, the present disclosure relates to a method for controlling a rock drilling rig comprising a primary power source and a secondary power source.

### BACKGROUND

Rock drilling rigs are used for several purposes, exploration drilling which aims to identify the location and quality of a mineral, and production drilling, used in the production-cycle in a mining or construction.

Traditionally, mining equipment such as rock drilling rigs have been driven by combustion engines. However, in recent years growing environmental concerns has driven the mining industry to reduce or phasing out the traditional combustion engine to reduce or eventually stop the emission of greenhouse gases from fossil fuels. Furthermore, the usage of combustion engines in underground mines also poses a problem in the working environment of the miners due to the exhaust gases emitted.

A proposed solution to such problems is the substitution of the combustion engine with an electrical motor. However, in such solutions, when a rock drilling rig performs its work cycle with a rock drilling machine, the rock drilling rig must be connected to an external electrical network for powering the rock drilling rig. This solution does eliminate direct emissions of CO₂ and usage of fossil fuels, but does however also provide several drawbacks. One exemplary drawback is that the connection to an external electrical network by a power cable, limits the movability of the machine, and could form an obstacle for other mining equipment devices in the same working area.

It would therefore be advantageous to provide a mining equipment solving the above stated problems.

### SUMMARY

An object of the present invention is to provide a rock drilling rig driven by an environmentally friendly power source. By environmentally friendly is meant a power source emitting less greenhouse gases than a conventional combustion engine when in use.

A further object of the present invention is to provide a rock drilling rig that is able to relocate between different work sites and/or a pitstop area and/or a maintenance area in a reliable manner.

Another object of the invention is to provide a system of mining equipment comprising at least a rock drilling rig. Thereby a mining equipment with increased safety and flexibility is achieved.

Another object of the present invention is to provide a method for controlling a rock drilling rig.

In a general aspect, the present invention is directed to a rock drilling rig, comprising at least a primary power source, a secondary power source and one control unit, wherein
the control unit is configured to control the rock drilling rig to perform work tasks according to a work cycle,
both the primary and the secondary power source are configured to selectively providing operating power to the rock drilling rig,
the primary power source is a fuel cell with a fuel tank,
and the secondary power source is an electrical battery, and
the control unit is additionally configured to control a charge of the electrical battery with power from the primary power source, simultaneously as supplying operating power to the rock drilling rig.

An exemplary effect of a rock drilling rig according to what is disclosed herein, is that the rock drilling rig is provided with high power resources, in combination with full movability both during relocation between work sites and when performing work tasks with the rock drilling machine, without any emissions of carbon dioxide.

An exemplary effect of a rock drilling rig according to what is disclosed herein, is that the electrical battery can be charged with electrical power from the primary power source while simultaneously supplying operating power to the rock drilling rig and without being connected to an external electrical grid, and simultaneously as the primary power source supplies power to the rock drilling rig.

A rock drilling rig comprises a carriage and rock drilling machine. The rock drilling machine is arranged on and connected to the carriage by means of a boom, so that the rock drilling unit can be arranged in different positions in relation to the carriage and to the rock to be drilled. Together, the carriage, rock drilling machine and the boom form the rock drilling rig. In the rock drilling rig disclosed herein both the primary and the secondary power source are configured to selectively providing operating power to the rock drilling rig. Operating power is the power for operating the any parts or operations of the rock drilling rig, such as propulsion power of carriage and/or working power of the rock drilling machine and/or any of the sub-systems of the rock drilling machine.

In one exemplary rock drilling rig, the primary power source is configured to provide propulsion power of carriage and/or working power of the rock drilling machine, and the secondary power source is configured to provide propulsion power and/or supporting operating power. Supporting operating power is the supplementary operating power requirement during a moment or a period of increased need for power output, such as when the rock drilling machine requires higher power increase than what the primary power source can deliver. This is especially advantageous due to high inertia of the fuel cell, which creates a time gap between an increased power requirement from the fuel cell and a corresponding power output from the fuel cell.

In one exemplary rock drilling rig, the primary power source is configured to provide propulsion power of carriage and/or working power of rock drilling machine, and the secondary power source is configured to provide supporting operating power and/or propulsion power to the carriage.

In one exemplary embodiment, the rock drilling rig is at least partially configured for autonomous control. This reduces the risk for miners and other workers operating the rig.

In one exemplary rock drilling rig, the electric battery of the secondary power source is dimensioned and configured for being able to propel the rock drilling rig during transfer drives with or without support from the primary power source and/or to support the primary power source during drilling operations with the rock drilling machine.

In one exemplary rock drilling rig, the electric battery of the secondary power source is dimensioned and configured for being able to deliver operating power for selectively propel the rock drilling rig without support from the primary power source and/or deliver operating power to the rock drilling machine without support from the primary power source.

A plurality of sensors can be arranged upon the rock drilling rig. The sensors are configured to monitor and produce data from individual devices of the rock drilling rig. Non limiting examples are the energy storage level of the first and secondary power source, spatial localisation of rock drilling rig and/or individual devices, spatial localisation of individual entities of the rig in relation to each other, temperature, pressure, current to and from electrical devices. The control unit is configured to receive, and process data from the plurality of sensors and control the rock drilling rig, it's individual parts and the interaction therebetween. A non-limiting example is the charging of the electrical battery dependent on at least the received and monitored data. Furthermore, the control unit can be a central control unit or a distributed arrangement, using the calculating power of a plurality of control units.

A work cycle can be a predefined work cycle or a dynamically updated work cycle, dependent on work area specific parameters. For a rock drilling rig exemplary work tasks are drilling and transportation between drill sites.

The work cycle to be performed by the rock drilling rig, can for instance be defined by an excavation plan in at least one working area in a mine. Excavation plan can for instance be, but not limited to, a drilling plan, a charging plan, or a mining plan. However, the skilled person understands that other operations can be performed as well.

According to one exemplary rock drilling rig, the control unit is configured to charge the electrical battery, only when the electrical battery delivers power to the rock drilling rig below a first threshold value.

By such an exemplary embodiment, an increase in battery lifetime is achieved since the battery can be continuously charged by the primary power source only when it is not used for powering the rig. This could for instance be simultaneously as the rig is in movement or in operation.

The first threshold value can be a specific power output from the electrical battery, or a threshold dependent on one or a plurality of parameters. Non limiting examples are a state of charge of the electrical battery, or a state of health of the electrical battery.

According to one exemplary rock drilling rig, the control unit is configured to determine the first threshold value, dependent on at least one of a state of health of the electrical battery, a state of charge of the electrical battery and an upcoming work task in the work cycle. This allows the threshold value to be optimally selected depending on different conditions or upcoming events, such as planned maintenance or planed displacement from one area to another. This ensures that the battery is sufficiently charged to propel the rock drilling rig in order to get to the planed place of arrival, without any power input from the primary energy source.

According to one exemplary rock drilling rig, the control unit controls the charge of the electrical battery with regard to the work tasks according to the work cycle of the rock drilling rig. Preferably, the control unit may control the charge of the electrical battery before a work task requiring the electrical battery to supply operating power above a predefined value.

By controlling the charging of the electrical battery with regard to the working tasks according to the work cycle of the rock drilling rig, it is possible to ensure that sufficient electrical power is available in the electrical battery of the rock drilling rig when needed. For instance, the electrical power in the electrical battery could be used to cover for the high inertia of the fuel cell during needs for instant high power output, to power the rig between different locations without the help of the fuel cell, to act as a power support to the fuel cell during high power operations, or to deliver operating power to perform a work task without the support from the fuel cell.

For instance, if a scheduled work task according to a work cycle requires a high power output, the electrical battery can be charged with power from the primary power source before said work task in order to ensure that sufficient power in the electrical battery is available to perform said task. The charging is preferably performed during a period of the work cycle when the primary power source is scheduled to deliver a low amount of operating power. This ensure that the charging of the electrical battery does not affect the operation of the rock drilling rig.

In another example, if the rock drilling rig is scheduled to perform a work task without the presence or support of the primary power source, for instance when propelling between different work sites and/or a pitstop area, the battery can be charged before said task by the primary power source.

According to one exemplary rock drilling rig, the rock drilling rig comprises a plurality of electrical batteries, wherein the control unit is configured to selectively power the rock drilling rig from any of the electrical batteries and/or selectively charge the electrical batteries from the fuel cell. This for instance enables simultaneous charge and use of electrical battery power, thus achieving a constant charge power to one battery while simultaneously varying power output from the other electrical battery.

According to one exemplary rock drilling rig, the rock drilling rig is provided with an interface for simultaneously receiving a plurality of fuel tanks for providing the fuel cell with fuel and the control unit is configured to control from which fuel tank the rock drilling rig is provided with fuel. By such an embodiment, exchange of fuel tanks without interruption of power output is achieved for instance.

Another general aspect of this disclosure concerns a system of mining equipment, comprising at least a rock drilling rig according to what is described herein, and a control unit, wherein
the rock drilling rig comprises a primary power source, a secondary power source, wherein
the control unit is configured to control the rock drilling rig to perform work tasks according to a work cycle,
both the primary and the secondary power source are configured to selectively providing operating power to the rock drilling rig,
the primary power source is a fuel cell with a fuel tank,
and the secondary power source is an electrical battery, and
the control unit is additionally configured to control a charge of the electrical battery with power from the primary power source, simultaneously as supplying operating power to the rock drilling rig, and
the system additionally comprises a plurality of fuel tanks for supplying power to the fuel cell.

The control unit can be the same control unit as provided in the rock drilling rig and/or be part of the same network of control units forming the distributed control unit.

An exemplary effect of the above defined system is that a tank for providing fuel to the fuel cell can be removed from the rock drilling rig and stored in a safe place, without inhibiting movement of the rock drilling rig. The fuel tank can be removed and/or exchanged to any one of the plurality of fuel tanks enabling a fast and safe refuelling of the rock drilling rig. The combination of a powering comprising an electrical battery, the rock drilling rig is able to between different areas using the electrical battery, such as between different works sites and/or a maintenance area, without the powering of the fuel cell.

One exemplary system comprises a plurality of mining equipment devices, and each mining equipment device is provided with a fuel cell as a primary power source, with an interface for receiving at least one fuel tank for providing the fuel cell with fuel.

Exemplary mining equipment devices, but not limited to, are rock drilling rigs, excavators, shovels, draglines, bulldozers, loaders, scrapers, skid steers, motor graders, off-highway dumpers, haul trucks, tank vehicles, water vehicles, forklifts, transport vehicles, cranes, conveyor systems, classifiers, crushers and/or multipurpose vehicles.

A work cycle can be a predefined work cycle or a dynamically updated work cycle, dependent on work area specific parameters. For a rock drilling rog exemplary work tasks are drilling and transportation between drill sites.

In one exemplary system the plurality of fuel tanks is interchangeable, such that each fuel tank can be provided at each interface of respective mining equipment device. One exemplary effect there of is that the fuel tanks can be changed between different mining equipment devices in order to optimise the work sites efficiency dependent on the total excavation plan and the individual mining equipment's work plans. E.g., a mining equipment device with a full or essentially full fuel tank and low power need, can exchange fuel tank with another mining equipment device with an empty or essentially empty fuel tank and a high power need.

In one exemplary system at least two different sizes of the plurality of interchangeable fuel cell tanks are provided. By such exemplary embodiment, better optimisation possibilities are achieved as an optimal size of the tank can be selected for a specific use. Another exemplary effect is that e.g., a rock drilling rig does not have to carry a larger fuel tank than needed for executing the working plan, wherein increased safety is achieved.

In one exemplary system, the system comprises at least one working area and at least one pitstop area, wherein
the working area is defined by the area within which the mining equipment devices are performing its work tasks and
the pitstop area is an area within which fuel tanks are allowed to be refilled and/or exchanged and/or stored, wherein
the working area and the pitstop area are separated and distanced from each other.

An exemplary effect of the above defined system is that it creates a safe working environment. A tank for providing fuel to the fuel cell can be removed from the rock drilling rig and stored in a pitstop area, which is arranged distanced to the working area. The rock drilling rig can be propelled from to e.g., a maintenance site without carrying any explosive fuel, which is safely stored in the pitstop area.

The working area can be defined by a working area boundary within which the mining equipment devices performs its work tasks. The pitstop area can be defined by a pitstop area boundary within which fuel tanks are allowed to be refilled and/or exchanged. In the context of this disclosure, the boundaries can be a virtual geographical boundary limiting a defined areas.

In one exemplary system according, a minimum distance between the pitstop area and any other defined area is dependent on the maximum amount of fuel the fuel tank and/or the type of fuel tank used.

By adjusting the minimum distance according to the maximum amount of fuel of the tank and/or the type of fuel tank used, the distance can be kept as low as possible without adventuring safety regulations. As the transfer distance is reduced to a minimum, this results for example in increased safety as well as reduced cost and improved efficiency. For instance, the minimum distance can be adjusted according to the type of fuel used and/or the type of fuel tank used.

In one exemplary system, the system further comprises at least one maintenance area, within which maintenance of the mining equipment devices is performed, is distanced to the at least one pitstop area and the working area.

By distancing a maintenance area and a pitstop area, it is for instance possible to remove and store the fuel tanks at the pit stop area in order to increase safety at the maintenance area. The rock drilling rig can transfer from the pitstop area to the maintenance area without the usage or presence of the primary power source, i.e., the fuel cell.

In one exemplary system, a maximum distance between the at least one pitstop area and the maintenance area is dependent on the size of the energy storage of the secondary power source. This ensures for example that the rock drilling rig and/or mining equipment can transfer between the pitstop area and the maintenance area with the available tank resources of the secondary drive power source.

Another general aspect of this disclosure concerns method for controlling a rock drilling rig, wherein the rock drilling rig comprises at least a primary power source and a secondary power source, and at least one control unit, wherein
the control unit is configured to control the rock drilling rig to perform work tasks according to a work cycle
both the primary and the secondary power source are configured to selectively providing operating power to the rock drilling rig,
the primary power source is a fuel cell with a fuel tank,
the secondary power source is at least one electrical battery, wherein
the control unit performs the method of:
detecting that the fuel cell is providing power to the rock drilling rig and thereby charging the at least one electrical battery, with power from the primary power source.

The method is adapted for any rock drilling rig disclosed herein.

An exemplary effect of the method is that when the control unit detects that the fuel cell is providing power to the rock drilling rig, it enables charging of the at least one electrical battery with power from the primary power source while the latter also supplies energy to the rock drilling rig. By controlling the charging of the electrical battery and taking the rock drilling rigs work cycle into account, enough energy in the electrical battery is available when needed. For instance, the electrical power in the electrical battery could be used to cover for the high inertia of the fuel cell during needs for high power output or for propelling the rock drilling rig without access to a fuel tank for the primary power source.

Additional exemplary method steps can be using the secondary power source for supplying electric power to the rock drilling rig, to serve as energy source during the transfer drive for moving the rock drilling rig between work areas, without the primary power source, and
charging the secondary power source with electricity obtained from the primary power source simultaneously during the drilling work cycle at the work area.

The detection by the control unit can for instance constitute receiving and process data from the plurality of sensors, and controlling the state of charge of the electrical battery.

In one exemplary method, the control unit further performs the method steps of: detecting the level of power the at least one electrical battery delivers to the rock drilling rig, and
determining if the level of power is below a predetermined threshold value, and thereby charging the at least one electrical battery with power from the fuel cell.

One exemplary effect thereof is an increase in battery lifetime, since the battery can be charged by the primary power source only when the secondary power source is not used for powering the rig. This could for instance be simultaneously as the rig is in transfer drive or during operation of the rock drilling machine.

The first threshold value can be a specific power output from the electrical battery, or a threshold dependent on one or a plurality of parameters. Non limiting examples are a state of charge of the electrical battery, or a state of health of the electrical battery.

In one exemplary method the control unit further performs the method steps of: determining the first threshold value dependent on at least one of a state of health of the at least one electrical battery, a state of charge of the at least one electrical battery and an upcoming work task in the work cycle. This allows the threshold value to be optimally selected depending on different conditions or upcoming events, such as planned maintenance or planed displacement from one area to another. This ensures that the battery is sufficiently charged to transfer the rock drilling rig in order to get to the planed place of arrival, even without the presence of the primary energy source.

### BRIEF DESCRIPTION OF THE DRAWINGS

The invention is now described, by way of example, with reference to the accompanying drawings, in which the same reference notations denote similar items in the various figures, and in which:

FIG. 1 illustrates a schematic representation of a rock drilling rig in accordance with an exemplary embodiment.

FIG. 2 illustrated a schematic representation of a system of mining equipment in accordance with an exemplary embodiment.

FIG. 3 shows a flowchart of a method according to an example.

FIG. 4 shows a flowchart of a method according to an example.

### DETAILED DESCRIPTION

The detailed description with reference to the disclosed embodiments are to be viewed as examples that combining specific features described above. It is to be understood that additional examples may be achieved by combining other and/or fewer/more features than in the disclosed embodiments. Hence, the figures disclose exemplary embodiments and not as exclusive combinations. In this context is should also be noted that, for the sake of simplicity, all figures are schematically disclosed, as long as nothing else is said.

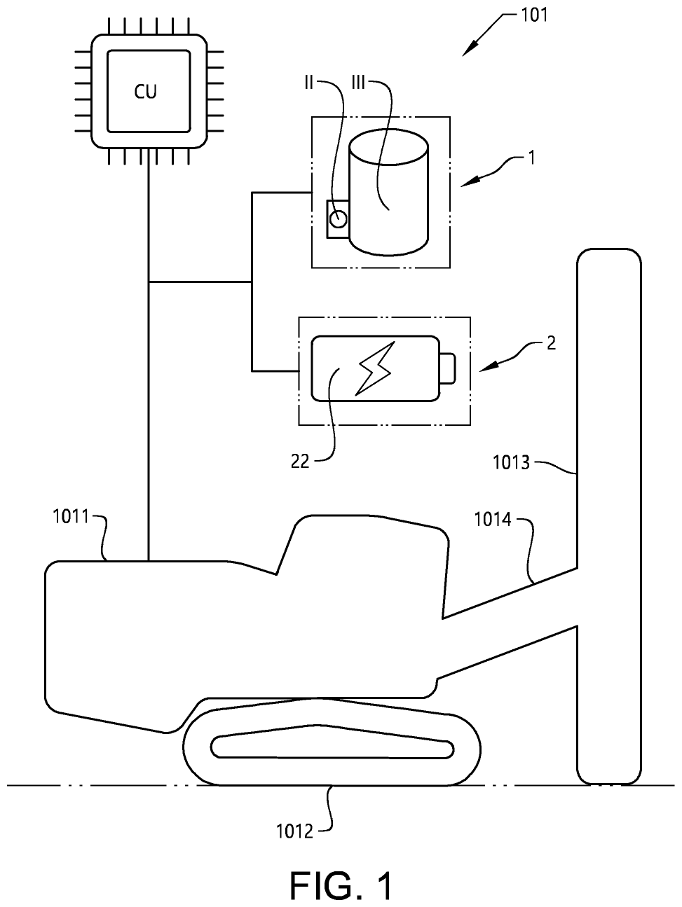

FIG. 1 shows a schematic representation of a rock drilling rig as disclosed herein. The rock drilling rig 101 of FIG. 1 comprises a carriage 1011 and a rock drilling machine 1013 attached to the front of the carriage 1011. The rock drilling machine 1013 is arranged on and connected to the carriage 1011 by means of a boom 1014, so that the rock drilling machine 1013 can be arranged in different positions in relation to the carriage 1011 and to the rock to be drilled. Together, the carriage 1011, rock drilling machine 1013 and the boom 1014 form the main part of the rock drilling rig 101. The carriage 1011 is further provided with moving means 1012 such as wheels or continuous track and propulsion equipment. The carriage 1011 further comprises a primary power source 1 comprising a fuel cell 11, which is provided with fuel from a fuel tank 111. The carriage 1011 further comprises a secondary power source 2 comprising an electric battery 22. The rock drilling rig 101 further comprises a control unit CU. The rock drilling rig 101 is provided with operative power by said primary 1 and/or secondary 2 power source. Operating power is the power for operating the any parts or operations of the rock drilling rig 101, such as propulsion power of carriage and/or working power of the rock drilling machine and/or any of the sub-systems of the rock drilling machine 1013. When the rock drilling rig 101 is operated, the control unit CU is configured to control a charge of the electrical battery 22 by using power from the primary 1 power source, simultaneously as supplying operating power to the rock drilling rig 101.

Both the primary 1 power source and the secondary 2 power source are configured to selectively provide operating power to the rock drilling rig 101. The secondary 2 power source is charged by the primary 1 power source. Preferably, the charging of the secondary 2 power source is only performed when the electrical battery 22 delivers power to the rock drilling rig 101 below a first threshold value. When a supporting power output might be needed, such as when an increase in power is required for a drilling operation, the high inertia of the fuel cell could lead to a power shortage. When this happens, the secondary 2 power source might act as a supporting power source for operating the rock drilling grid, thus ensuring that sufficient power output is always available.

The electric battery 22 of the secondary 2 power source can be dimensioned and configured for being able to propel the rock drilling rig 101 during transfer drives with or without support from the primary 1 power source and/or to support the primary 1 power source during drilling operations with the rock drilling machine 1013.

Alternatively the electric battery 22 of the secondary 2 power source can be dimensioned and configured for being able to deliver operating power for selectively propel the rock drilling rig without support from the primary 1 power source and/or deliver operating power to the rock drilling machine 1013 without support from the primary 1 power source.

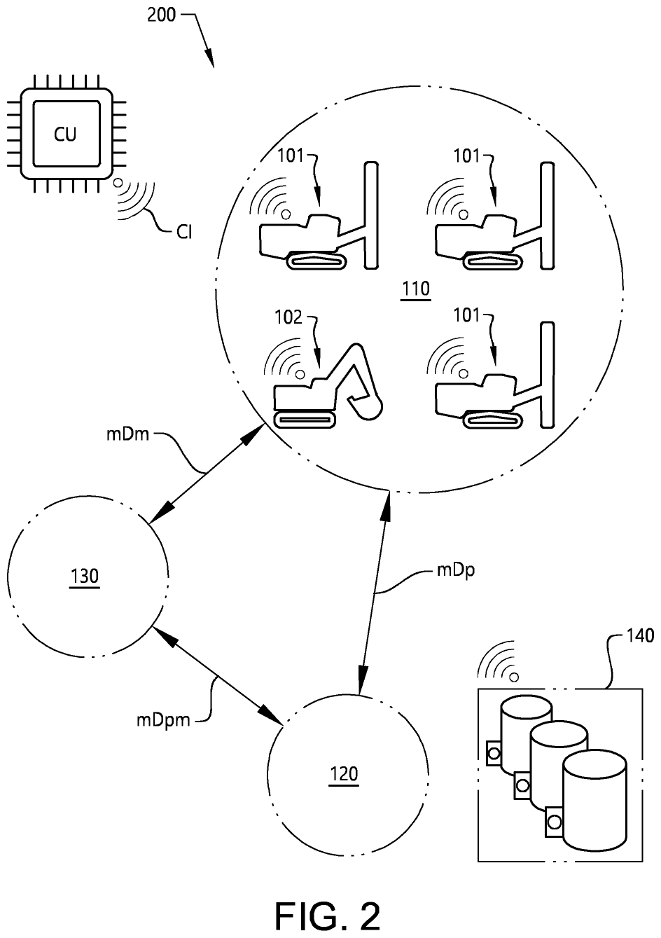

FIG. 2 shows a schematic representation of a system of mining equipment according to one possible embodiment of the present invention. The system 200 comprises at least one rock drilling rig 101 and a control unit CU. The rock drilling rig 101 comprises a primary power source 1 comprising a fuel cell 11 and fuel tank 111. The rock drilling rig 101 further comprises a secondary power source 2 comprising an electrical battery 22. The system described in FIG. 2 further comprises an additional mining equipment devices 102, in this case an excavator. Other exemplary mining equipment devices, but not limited to, are rock drilling rigs, excavators, shovels, draglines, bulldozers, loaders, scrapers, skid steers, motor graders, off-highway dumpers, haul trucks, tank vehicles, water vehicles, forklifts, transport vehicles, cranes, conveyor systems, classifiers, crushers and/or multipurpose vehicles. In the schematic representation illustrated in FIG. 2, a rock drilling rig 101 and an excavator are the mining equipment devices present in the system.

The system 200 illustrated in FIG. 2 further comprises a working area 110 in which the mining equipment devices are performing its work tasks, a pitstop area 120 in which fuel tanks are allowed to be refilled and/or exchanged and/or stored. The working area 110 and the pitstop area 120 are separated and distanced from each other by a boundary. The working area 110 and the pitstop area 120 are distanced from each other by a minimal distance mDp, wherein said minimal distance mDp is selected for instance depending on to the type of gas used inside the fuel tank and/or the type of fuel tank used. In the embodiment illustrated by FIG. 2, a plurality of fuel tanks 140 is located at the pitstop area 120 for supplying power to the fuel cell 11. When the rock drilling rig 101 is driven to the pit stop area, an empty fuel tank can be substituted by one or more new ones.

FIG. 2 additionally schematically discloses a communication interface CI providing a data link between each mining equipment device in the working area 110, pitstop area 120 and/or maintenance area 130. The control unit CU can as before be part of a distributed network of control units, i.e., a fog- and/or cloud-computation system.

The system 200 illustrated in FIG. 2 further comprises a maintenance area 130 within which maintenance of the mining equipment devices is performed. The maintenance area and the working area 110 are separated from each other by a minimal distance mDm. The maintenance area 130 and the pitstop area 120 are separated from each other by a minimal distance mDpm. As previously described, in one preferred embedment of the invention, the rock drilling rig 101 moves from the pitstop area 120 to the maintenance area 130 utilizing the power from the secondary power source 2 as the primary power source 1 is dropped at the pitstop area 120 for safety concerns.

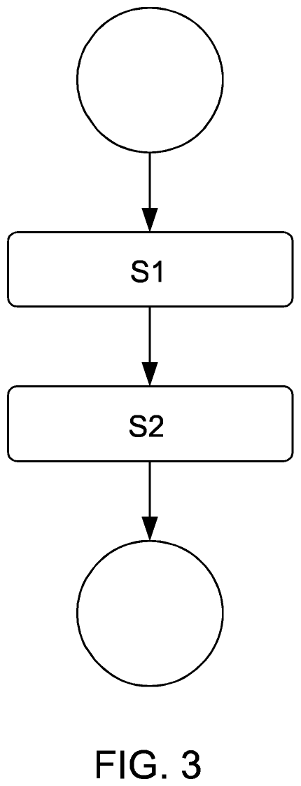

FIG. 3 shows a flowchart of a method according to an embodiment of the present disclosure. The method is performed by a control unit CU, for controlling a rock drilling rig 101 as disclosed in claim 1 The method comprising detecting S1 that the fuel cell 11 is providing power to the rock drilling rig 101 and charging S2 the at least one electrical battery 22 with power from the primary 1 power source.

The detection S1 can be done by receiving and processing data from a plurality of sensors provided at the rock drilling rig 101. The of sensors are configured to monitor and produce data from individual devices of the rock drilling rig. Non limiting examples are the energy storage level of the first and secondary power source, spatial localisation of rock drilling rig and/or individual devices, spatial localisation of individual entities of the rig in relation to each other, temperature, pressure, current to and from electrical devices. Based on the received and monitored data from the plurality of sensors, the control unit CU is configured to process said data a control the charging of the electrical battery. The control unit CU can be a central control unit or a distributed arrangement of a plurality of control units.

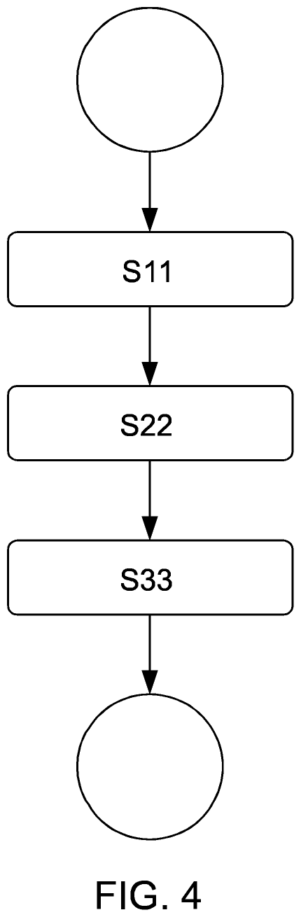

FIG. 4 shows a flowchart of a method according to an embodiment of the present invention. The method is performed by a control unit CU, for charging at least one electrical battery 22 with power from a primary 1 power source of a rock drilling rig 101. The method comprising detecting S11 the level of power the at least one electrical battery 22 delivers to the rock drilling rig 101 and determining S22 if the level of power is below a predetermined threshold value, and thereby charging S33 the at least one electrical battery with power from the fuel cell 22. If for instance the electrical battery 22 is supplying none or little power to the rock drilling rig 101, it is possible to charge the battery 22 without damaging it. Also, by ensuring that the battery is sufficiently charged for a planned use or movement, the rock drilling rig 101 can be operated without the usage of the primary 1 power source. It is also important that the battery is sufficiently charged during operation of the rock drilling rig 101 if a sudden increase of power output is needed, as the high inertia of the fuel cell could create a power shortage.

1. A rock drilling rig, comprising at least a primary power source, a secondary power source and one control unit, wherein
the control unit is configured to control the rock drilling rig to perform work tasks according to a work cycle,
both the primary and the secondary power source are configured to selectively providing operating power to the rock drilling rig,
the primary power source is a fuel cell with a fuel tank,
the secondary power source is an electrical battery, and
the control unit is additionally configured to control a charge of the electrical battery with power from the primary power source, simultaneously as supplying operating power to the rock drilling rig.

2. The rock drilling rig according to claim 1, wherein the control unit is configured to charge the electrical battery, only when the electrical battery delivers power to the rock drilling rig below a first threshold value.

3. The rock drilling rig according to claim 2, wherein the control unit is configured to determine the first threshold value, dependent on at least one of a state of health of the electrical battery, a state of charge of the electrical battery and an upcoming work task in the work cycle.

4. The rock drilling rig according to claim 1, wherein the control unit controls the charge of the electrical battery with regard to the work tasks according to the work cycle of the rock drilling rig.

5. The rock drilling rig according to claim 1, wherein the rock drilling rig comprises a plurality of electrical batteries, wherein the control unit is configured to selectively power the rock drilling rig from any of the electrical batteries and/or selectively charge the electrical batteries from the fuel cell.

6. The rock drilling rig according to claim 1, wherein the rock drilling rig is provided with an interface for simultaneously receiving a plurality of fuel tanks for providing the fuel cell with fuel and the control unit is configured to control from which fuel tank the rock drilling rig is provided with fuel.

7. A system of mining equipment, comprising at least a rock drilling rig, and a control unit, wherein
the rock drilling rig comprises a primary power source and a secondary power source, wherein
the control unit is configured to control the rock drilling rig to perform work tasks according to a work cycle,
both the primary and the secondary power source are configured to selectively providing operating power to the rock drilling rig,
the primary power source is a fuel cell with a fuel tank,
the secondary power source is an electrical battery, wherein
the control unit is additionally configured to control a charge of the electrical battery with power from the primary power source, simultaneously as supplying operating power to the rock drilling rig, and
the system additionally comprises a plurality of fuel tanks for supplying power to the fuel cell.

8. The system according to claim 7, wherein the system comprises a plurality of mining equipment devices, and each mining equipment device is provided with a fuel cell as a primary power source, with an interface for receiving at least one fuel tank for providing the fuel cell with fuel.

9. The system according to claim 7, wherein the plurality of fuel tanks is interchangeable, such that each fuel tank can be provided at each interface of respective mining equipment device.

10. The system according to claim 7, wherein at least two different sizes of the plurality of interchangeable fuel cell tanks are provided.

11. The system according to claim 7, wherein the system comprises at least one working area and at least one pitstop area, wherein
the working area is defined by the area within which the mining equipment devices are performing its work tasks,
the pitstop area is an area within which fuel tanks are allowed to be refilled and/or exchanged and/or stored, and
the working area and the pitstop area are separated and distanced from each other.

12. The system according to claim 7, wherein a minimum distance between the pitstop area and any other defined area is dependent on the maximum amount of fuel the fuel tanks and/or the type of fuel tank used.

13. The system according to claim 12, wherein the system further comprises at least one maintenance area, within which maintenance of the mining equipment devices is performed, is distanced to the at least one pitstop area and the working area.

14. The system according to claim 13, wherein a maximum distance between the at least one pitstop area and the maintenance area is dependent on the size of the energy storage of the secondary power source.

15. A method for controlling a rock drilling rig, wherein the rock drilling rig comprises at least a primary power source and a secondary power source, and at least one control unit, wherein
the control unit is configured to control the rock drilling rig to perform work tasks according to a work cycle
both the primary and the secondary power source are configured to selectively providing operating power to the rock drilling rig,
the primary power source is a fuel cell with a fuel tank,
the secondary power source is at least one electrical battery, wherein
the control unit performs the method of:
detecting that the fuel cell is providing power to the rock drilling rig and thereby
charging the at least one electrical battery, with power from the primary power source.

16. The method according to claim 15, wherein the control unit further performs the method steps of:
detecting the level of power the at least one electrical battery delivers to the rock drilling rig, and
determining if the level of power is below a predetermined threshold value, and thereby
charging the at least one electrical battery with power from the fuel cell.

17. The method according to claim 16, wherein the control unit further performs the method steps of:
determining the first threshold value dependent on at least one of a state of health of the at least one electrical battery, a state of charge of the at least one electrical battery and an upcoming work task in the work cycle.
